(19) United States
(12) Patent Application Publication
(10) Pub. No.: US 2010/0219361 A1
(43) Pub. Date: Sep. 2, 2010

(54) ROTARY GAS TAP WITH AN INTEGRAL ELECTROMAGNETIC VALVE

(75) Inventors: Francisco Javier Echenagusia Saez de Zaitegui, Aretxavaleta (Gipuzkoa) (ES); Félix Querejeta Andueza, Victoria-Gasteiz (Alava) (ES); José Ignocio Múgica Odriozola, Bergara (Gipuzkoa) (ES)

Correspondence Address: Berenbaum Weinshienk PC, 370 Seventeenth Street, Republic Plaza, Suite 4800, Denver, CO, 80202, US

(73) Assignee: MONDRAGON COMPONENTES, S. COOP, Aretxabaleta Gipuzkoa (ES)

(21) Appl. No.: 12/301,007

(22) PCT Filed: Apr. 27, 2007
(86) PCT No.: PCT/ES2007/070085

§ 371 Date: Aug. 12, 2009

(30) Foreign Application Priority Data
May 16, 2006 (ES) U 20060113

(51) Int. Cl. F16K 31/02

(52) U.S. Cl. 251/129.15

(57) ABSTRACT

The rotary gas tap (1) with an electromagnetic safety valve (3), is of the conical regulation member (7) type, and the electromagnetic actuator (3a), being of a smaller power and size, is built entirely into a pipe housing (2a) in the body of the tap. The valve actuator (3a) is of the type where the seal member (9) is lifted by means of a DC voltage. The cylindrical magnetic frame (14) penetrating into the coil (15) is guided inside it, and a magnetic capsule (16) surrounding the coil is of a diameter Dh of around 14 mm, adjusted to that of the housing (8) in the body of the tap (2a). The stroke “R” of the seal member (9) corresponds to a gap (G) greater than 2.5 mm, reaching a sizeable passage opening “A” in the valve (9,10) necessary for a maximum inlet flow (Q) in the tap. At the same time the electromagnetic actuator (3a) is of low power, by means of a low reluctance in the magnetic circuit (13-16), although the diameter “Da” of the cylindrical frame is restricted to less than 4 mm.

The present invention relates to a rotary-type gas tap for the regulation of a flow in a domestic appliance, with an electromagnetic safety valve built into a gas-flow pipe inside the tap, operated and kept open by an external DC voltage.

### PRIOR ART

There known rotary gas taps of the type mentioned above that are adapted to a domestic cooking appliance or stove wherein an electromagnetic safety valve is built into a gas-flow pipe regulated by means of a conical regulation member. The valve actuator coil is operated initially by a manual ram or a DC voltage in order to attract the magnetic frame and open the valve, and is then kept open by a low-intensity electrical current, conditioned to a flame presence sensor.

EP-A-1045206 (ES-2161601-A) discloses a rotary gas tap that regulates a flow by means of a conical regulation member, wherein an electromagnetic actuator of a safety valve is built into an additional tubular housing secured by a threaded joint on the free end and provided with an electrical connector for a Vdc operating voltage.

WO-2004/031632-A discloses a rotary gas tap adapted to a domestic cooker, with an electromagnetic safety valve operated by a DC voltage from an external source and comprising an electromagnet with a moving cylindrical frame projecting into the coil, which solves the problem of an electromagnet actuator with sufficient attraction force to attract a frame with a sizeable gap to lift the seal member sufficiently. This valve actuator has a large coil that is coupled to the body of the tap on the outside of the valve housing, and may be dismantled to enable it to be replaced. As well as requiring a high electrical power, an electromagnetic actuator as large as this generates significant impacts on the magnetic frame, and as it is made up of two separable parts, additional guide means are required for the moving frame and airtight means for the fixed core.

### DISCLOSURE OF THE INVENTION

It is the object of the invention to provide a rotary gas tap adapted to a domestic cooking or heating appliance, with an electromagnetic safety valve built into the body of the tap, wherein the electromagnetic actuator is of the small, compact type and driven by a low external Vdc voltage, and has a moving, cylindrical magnetic frame guided axially inside the coil, which effects with the seal member a lifting stroke “R” that is sufficiently long for the valve opening width necessary to allow the passage of a maximum inlet flow in the tap without charge loss.

The electromagnetic safety valve built into a pipe of the rotary gas tap has a low-power electromagnet due to the reduced size of the valve actuator, which must be adjusted to the diameter of the tubular housing pipe. The entire electromagnetic actuator is built into the body of the tap using a small, low-power coil, and means for coupling the actuator in the pipe of the body that are of a simple construction and cheap, the closure member and the moving frame being capable of attracting a long gap of 2.5 mm or more despite their small size and the low supply current, also generating an attraction force that exceeds a nominal force, for the purposes of facilitating the operation when, over the passage of time, the reluctance of the electromagnet is reduced due to the wear of the magnetic contact surfaces of the moving frame and the counter-frame in the core.

The electromagnet actuator is of low power and, at the initial moment of operation, generates an attraction force in the moving frame that is also sufficient for lifting, from the valve seating, a rubber seal, overcoming the resistance of the “sticking” in addition to the force of the return spring. Although the electromagnet of the safety valve has to be small in size so that it may be built into the body of the tap, it is built with a long gap that enables sizeable lifting of the seal member, thereby ensuring a sufficient area of valve opening for the passage of all the gas flow accessing the tap inlet. The high reluctance of the magnetic circuit caused by the long air gap between the moving frame and the core is compensated for by good magnetic closures at both ends of the steel casing of the electromagnet, and with minimum play in the movement between the frame and the coil.

### DESCRIPTION OF THE DRAWINGS

FIG. 1 is a cross-sectional view of a rotary gas tap with a built-in electromagnetic safety valve.

### DETAILED DISCLOSURE OF THE INVENTION

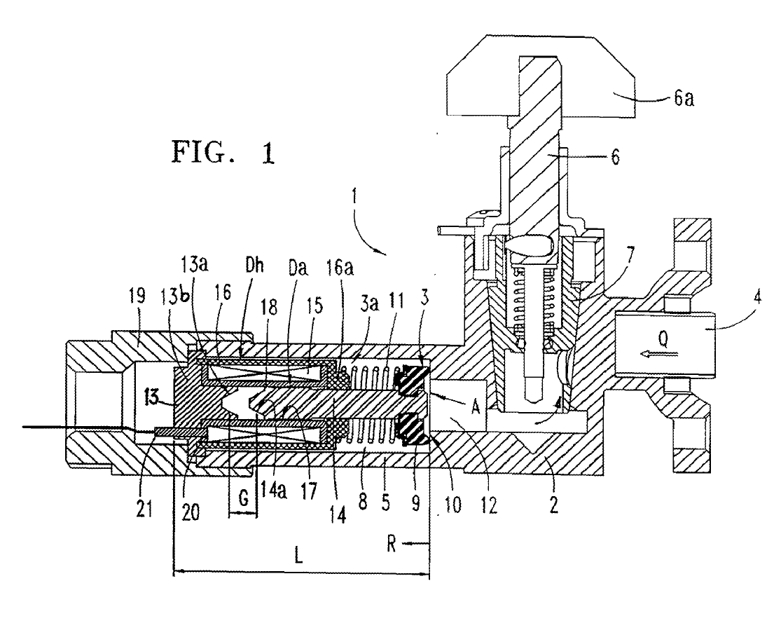

With reference to FIG. 1, a preferred embodiment of the rotary gas tap 1 with an electromagnetic safety valve 3 built into the compact body 2 of the tap comprises a rotary tap axis 6 with a control button 6a that manually regulates a main gas flow “Q” adapted to a domestic gas appliance, such as a cooker or a heating stove, between an inlet pipe 4 and an outlet pipe 5 in the tap body. The regulation member 7 is of the conical type and the safety valve 3 built into the tap body 2 comprises an electromagnetic actuator 3a with a seal member 9 of a material that is flexible against the force of a return spring 11. In an embodiment such as the one shown in FIG. 1, the housing 8 for the electromagnetic actuator 3a is built into a gas pipe 2a connected to the inlet pipe 4 in the tap, its diameter being adjusted to the small diameter “Dh” of the actuator 3a, around 12 mm. At the bottom of the pipe-housing 8 is built a seating 10 of the safety valve and a valve hole 12 that provides a opening section “A” for the passage of the maximum flow “Q” without charge loss.

The electromagnetic actuator 3a of the safety valve comprises an electromagnet 13,14,15 with a coil 15 for lifting the seal member 9, and is coupled in its entirety inside the housing 8, tightened against the pipe of the body 2a by means of a connector 19 threaded on its free end. On the other end of the pipe 2a, the seal 9 of the valve is pressed against the valve seating 10 pushed by the return spring 11. The moving magnetic frame 14 that carries the seal 9 is cylindrical in shape and has a diameter of around 4 mm, it being guided inside the tubular reel of the operating coil 15.

The ferromagnetic core 13 of the electromagnet comprises an external base 13b in the form of a disc, on which the coil 15 is supported, and electrically connects the “mass” of the tap, and an internal cylindrical segment 13a that penetrates into the coil 15, operating as a fixed counter-frame 13a. Between the counter-frame 13a and the moving frame 14 of the electromagnet is formed a long air gap “G” of between 2.5 and 5 mm, preferably 3 mm. The contact surfaces 14a of the moving frame and the counter-frame 13a have a substantially conical configuration, one of them complementary to the other to enable a male/female fitting between them, so that the area of contact between them is increased. The reluctance of the magnetic circuit is thus reduced in relation to the flat, cylindrical, cross-sectional contact frame that forms part of the prior art referred to in the introduction.

The coil 15 is enclosed in a magnetic steel capsule 16 which acts as a collector of the magnetic flow, completing the magnetic circuit of attraction between the moving frame 14 and the core 13. The magnetic capsule 16 is inserted tightly on a base of the core 13, forming a magnetic closure 20 against it. Said base 13b also includes a ring-shaped sector external to the capsule 16, offering a peripheral surface for the airtight closure of the electromagnet 13-16 in its pipe housing in the body 2a, the entire electromagnetic actuator 3a thus being coupled inside the tap 1.

The operating coil 15 is of low power, around 40 mW, and the cylindrical capsule 16 that surrounds the coil is of a small diameter “Dh”, around 12 mm or smaller than 14 mm, and the coupling means 13-21 of the electromagnetic actuator 3a are of a simple construction and cheap. The electrical power of the coil 15 and the number of thread turns, around 1,700 turns and 100 ohms, are adapted to said diameter “Dh” of the surrounding steel capsule 16, and to a total actuator length “L” of approximately 33 mm. The force necessary to keep the frame 14 attracted and the safety valve 3 open is generated in the coil with the magnetic field of around 34 Amps per turn. An electrical connector 21 for the coil 15 passes through the base of the core 13b, insulated electrically from it and projecting outwards, for the supply of an external Vdc operating voltage of around 65/80 Vdc.

The opposite end of the steel capsule 16 close to the seal member 9 is closed against a collar 16a for guiding the moving frame 14, which is adjusted to the diameter

“Da” of the frame 14, around 4 mm, the purpose being to reduce to a minimum the reluctance of the magnetic closure 16. In order to guide it during movement, the cylindrical frame 14 has a ring-shaped sliding ridge 18 inside the reel of the coil 15, which projects slightly from the cylindrical surface of the frame 14, with the aim of not increasing the play between the coil 15 and the frame 14.

Through the construction of the electromagnetic actuator 3a described above the force necessary for operating the electromagnet 13,14,15 is always guaranteed, with the attraction of the frame 14 enabling a lifting stroke “R” of the seal member 9 greater than 2.5 mm, preferably 3 mm. When the valve hole 12 is, for example 6 mm, this minimum stroke “R” value contributes to the creation of a passage opening “A” in the valve 9,10 and of a sufficient area to enable a maximum flow “Q” to be transmitted from the inlet pipe 4.

The diameter “Da” of the moving frame for reducing the size of the electromagnet 13-16 and enabling it to be built into the pipe of the tap 2a is smaller than two times the length of the gap “G” necessary for the lifting stroke R greater than 2.5 mm of the seal 9.

A sizeable lifting “R” of the seal member 9, greater than 2.5 mm, is thus achieved, and at the same time a low reluctance of the electromagnet 13-16 to ensure it is operational during a long period of time, thereby generating the necessary electromagnet force to compensate for the wear and the resistance of the “sticking” of the seal member 9 against the valve seating 10, and the increase in the reluctance of the electromagnet due to the wear of the magnetic contact surfaces 13a, 14a caused by the impacts of the frame 14.

What is claimed is:

1. (canceled)

2. (canceled)

3. (canceled)

4. (canceled)

5. (canceled)

6. A gas tap having a built-in electromagnetic safety valve for the regulation of a gas flow to a domestic cooking appliance or a stove, the gas tap having a tap body and a regulation member located within the tap body for regulating the gas flow through the tap, the safety valve located within a housing of a pipe situated downstream the regulation member, the housing having an inlet opening to permit gas flow through the housing to a gas outlet, the safety valve having a small, compact type, low-power electromagnetic actuator coupled to a seal member that is urged by a spring to rest against a seat to occlude flow through the opening, the actuator comprising a small coil powered by a DC voltage, a magnetic frame located and moveable within the coil that has a first surface, and a stationary magnetic core having a base and a second surface located within the coil and opposing the first surface of the magnetic frame, the distance between the first and second surfaces being relatively large relative to the length of the electromagnetic actuator when the seal member rests against the seat, the actuator configured to move the seal member off the seat to permit a maximum gas flow through the gas tap when a low supply current passes through the coil.

7. A gas tap according to claim 6 wherein the first and second surfaces are shaped to minimize the reluctance of a magnetic circuit of the electromagnetic actuator.

8. A gas tap according to claim 6 wherein the first and second surfaces are non-flat.

9. A gas tap according to claim 8 wherein the first and second non-flat surfaces have a substantially conical configuration.

10. A gas tap according to claim 6 wherein the ratio of the length of the electromagnetic actuator with the distance between the first and second surfaces is between about 6.6 and about 14.0.

11. A gas tap according to claim 6 wherein the ratio of the length of the electromagnetic actuator with the distance between the first and second surfaces is between about 11.0 and about 11.6.

12. A gas tap according to claim 6 wherein the coil is located within a magnetic capsule, the magnetic capsule forming a part of a magnetic circuit of the electromagnetic actuator.

13. A gas tap according to claim 12 wherein the external diameter of the magnetic capsule is less than about 14 millimeters and the length of the electromagnetic actuator is less than about 35 millimeters.

14. A gas tap according to claim 13 wherein the distance between the first and second surfaces is between about 2.5 and about 5.0 millimeters.

15. A gas tap according to claim 6 wherein the external diameter of the magnetic frame is less than around two times the distance between the first and second surfaces.

16. A gas tap according to claim 14 wherein the external diameter of the magnetic frame is less than around two times the distance between the first and second surfaces.

17. A gas tap according to claim 16 wherein the external diameter of the magnetic frame is about 4.0 millimeters.

18. A gas tap according to claim 14 wherein the safety valve is configured to produce a lifting stroke of the seal member of greater than about 2.5 millimeters.

19. A gas tap according to claim 12 wherein the base of the stationary magnetic core has a portion for engaging a first end of the magnetic capsule to close the magnetic circuit of the electromagnetic actuator, the base also having a peripheral ring-shaped surface for the airtight closure of the electromagnetic actuator against an inner wall surface of the pipe.

20. A gas tap according to claim 19 wherein the magnetic capsule is closed on a second end near the seal member by a collar.

21. A gas tap according to claim 12 wherein the magnetic frame has a ring-shaped ridge that is slideable along an inner surface of the magnetic capsule.

22. A gas tap according to claim 6 wherein the operating DC voltage is around 65/80 Vdc.

23. A gas tap having a built-in electromagnetic safety valve for the regulation of a gas flow to a domestic cooking appliance or a stove, the gas tap having a tap body and a regulation member located within the tap body for regulating the gas flow through the tap, the safety valve located within a housing situated downstream the regulation member, the housing having an inlet opening to permit gas flow through the housing to a gas outlet, the safety valve having a small, compact type, low-power electromagnetic actuator coupled to a seal member that is urged by a spring to rest against a seat to occlude flow through the opening, the actuator comprising a coil powered by a DC voltage, a magnetic frame located and moveable within the coil that has a first surface, and a stationary magnetic core having a base and a second surface located within the coil and opposing the first surface of the magnetic frame, the ratio of the length of the electromagnetic actuator with the distance between the first and second surfaces is between about 6.6 and about 14.0 when the seal member rests against the seat, the actuator configured to move the seal member off the seat to permit a maximum gas flow through the gas tap when a low supply current passes through the coil.

24. A gas tap according to claim 23 wherein the operating DC voltage is around 65/80 Vdc.

25. A gas tap having a built-in electromagnetic safety valve for the regulation of a gas flow to a domestic cooking appliance or a stove, the gas tap having a tap body and a regulation member located within the tap body for regulating the gas flow through the tap, the safety valve located within a housing of a pipe situated downstream the regulation member, the housing having an inlet opening to permit gas flow through the housing to a gas outlet, the safety valve having a small, compact type, low-power electromagnetic actuator coupled to a seal member that is urged by a spring to rest against a seat to occlude flow through the opening, the actuator having a small coil powered by a DC voltage around 65/80 Vdc and located within a magnetic capsule, a magnetic frame located and moveable within the coil that has a first surface, and a stationary magnetic core having a base and a second surface located within the coil and opposing the first surface of the magnetic frame, the ratio of the length of the electromagnetic actuator with the distance between the first and second surfaces is between about 6.6 and about 14.0 when the seal member rests against the seat, the actuator configured to move the seal member off the seat to permit a maximum gas flow through the gas tap when a low supply current passes through the coil, the external diameter of the magnetic capsule being less than about 14 millimeters and the length of the electromagnetic actuator being less than about 35 millimeters, the distance between the first and second surfaces being between about 2.5 and about 5.0 millimeters, the external diameter of the magnetic frame being less than around two times the distance between the first and second surfaces, the safety valve configured to produce a lifting stroke of the seal member of greater than about 2.5 millimeters.

26. A gas tap according to claim 25 wherein the base of the stationary magnetic core has a portion for engaging a first end of the magnetic capsule to close a magnetic circuit of the electromagnetic actuator, the base also having a peripheral ring-shaped surface for the airtight closure of the electromagnetic actuator against an inner wall surface of the pipe, the magnetic capsule closed on a second end near the seal member by a collar.
